(19) United States
(12) Patent Application Publication
(10) Pub. No.: US 2011/0284520 A1
(43) Pub. Date: Nov. 24, 2011

(54) Heater Wire Control Circuit and Method to Operate a Heating Element

(75) Inventor: Yi-Liang Fong, Taipei County (TW)

(73) Assignee: MICROLIFE INTELLECTUAL PROPERTY GMBH, Widnau (CH)

(21) Appl. No.: 13/054,707

(22) PCT Filed: Jul. 10, 2009
(86) PCT No.: PCT/EP2009/058857

§ 371 Date: Apr. 20, 2011

(30) Foreign Application Priority Data
Jul. 17, 2008 (EP) 08104776.3

(51) Int. Cl. H05B 1/02

(52) U.S. Cl. 219/494

(57) ABSTRACT

A heater wire control circuit (1) to control the AC power supply of a connected heating element (21) comprises an interrupting means (31) having at least three switching states with regard to the AC power supplied to the heating element (21), e.g. both half-waves on, positive or negative half-wave off and both half-waves off, and a control means (32) to determine the temperature of the heating element (21) and an to decide on the switching status of the interrupting means (31) depending on said temperature and/or a user setting.

The present invention relates to a heater wire control circuit and a method to operate a heating element as it might be used in a heating blanket or heating pad.

Various examples of heater wire control circuits and corresponding methods to operate a heater wire are known in prior art.

U.S. Pat. No. 5,861,610 describes a heater wire with integral sensor and a controller for the same. The heater wire with integral sensor basically consists of a first helically wound conductor used as a heating element, a second helically wound conductor arranged coaxially to the first conductor used as a sensing element and a flexible and thermo-conductive electrical insulator between the two conductors. The second wire has a positive temperature coefficient (PTC) thus increasing its resistance with higher temperature. Depending from the resistance, the power output to the heating wire is adjusted. In case of severe overheat, the flexible and thermo-conductive electrical insulator between the two conductors deteriorates and the two conductors will make electrical contact which might be detected by an electronic control unit and the power being interrupted.

In U.S. Pat. No. 6,222,162 an electric heating element and a control circuit are disclosed. The heating element consists of a polymer core with a conductor helically wound around it. The conductor is used as a heating wire. Due to its positive temperature coefficient (PTC) the resistance increases with higher temperature. This change of resistance of the heating conductor is measured and the control circuit regulates the power to the heating wire.

U.S. Pat. No. 6,310,332 discloses a heating blanket with a heating element and an electronic controller. The heating element basically consists of a first conductor to provide heat for the blanket, a second conductor and a meltdown layer between the first and second conductors. The meltdown layer displays a negative temperature coefficient (NTC), thus the resistance between the two conductors is decreasing with higher temperature. Only positive or negative half-waves of the AC power are supplied to the heating element under normal use. The controller detects a change of resistance of the meltdown layer, controls the power output for the heating element and prevents the destruction of the heating element.

One major disadvantage of the prior art heating elements and heater wire controls is that only a change of uniform or average temperature of the heater wire is detected. In case of overheat of a small part of the heater wire due to punching or kinking of the heating element, the hot spot is not detected which leads to destruction of the heater wire.

It is an object of the present invention to overcome the disadvantages of the devices known from prior art.

A heater wire control circuit to control the AC power supply of a connected heating element in accordance to the present invention comprises an interrupting means having at least three switching states with regard to the AC power supplied to the heating element, e.g. both half-waves on, positive or negative half-wave off and both half-waves off, and a control means to determine the temperature of the heating element and to decide on the switching status of the interrupting means depending on said temperature and/or a user setting.

During normal operation of the heating element, the full AC power, e.g. both half-waves on, will be supplied to the heating element to heat it up. When the heating element reaches a certain temperature level or a hot spot on the heating element occurs, then the power supply will be reduced, e.g. by switching to positive or negative half-wave off. The power applied is reduced and the heating element can cool down. If further reduction of the power is needed, e.g. due to severe overheat caused by folding of the heating element, the interrupting means can be switched to both half-waves off, allowing a complete cool down of the heating element.

The interrupting means can comprise semiconductor switches to realise the different switching states. But also mechanical, electromechanical and/or a combination of such switches can be used.

The heater wire control circuit might further comprise a trigger device to switch the interrupting means to both half-waves off at every positive and/or negative zero crossing of the AC power for a given length of time T1, and/or as long as the voltage during the rising slope of the AC input voltage is below a predetermined threshold value, enabling the control means to determine the temperature of the heating element.

According to the present invention, another embodiment of a heater wire control circuit to control the AC power supply of a connected heating element, which can be regarded at its own or in combination with the above mentioned embodiment, comprises means to determine the temperature of the heating element at every positive and/or negative half-wave and to set the power supply to the heating element depending on said temperature.

This means may comprise an operating circuit and a switching element. The operating circuit is able to stop the power supply to the heating element depending on the temperature of the heating element when power is applied. The operating circuit is further able to determine the temperature of the heating element by measuring any electrical characteristic of the heating element which is related to the temperature, e.g. its voltage drop, its current or its resistance.

The switching element provides a connection between the operating circuit and the heating element for a given length of time T1, and/or as long as the voltage during the rising slope of the AC input voltage is below a predetermined threshold value. This connection is needed in order to measure or determine the temperature of the heating element. This connection will not be of a permanent nature but will be established by the switching element regularly for a certain time. This time can either be a preset time T1, preferably a fraction of the AC period or can be depending on the duration of AC input voltage to reach a certain predefined threshold value.

The starting point of the time T1 preferably is at each positive and/or negative zero crossing of the AC power. The duration of the time T1 is less than 10%, preferably between 0% and 5%, most preferably between 0.25% and 1.5% of the AC period. The predetermined threshold value is less than 50%, preferably between 0% and 30%, most preferably between 1.5% and 9.5% of the AC line voltage. Other values are possible for the threshold voltage and/or the time T1.

The regularity of the determination of the temperature of the heating element is at least once every AC period, preferably starting at a zero crossing of the AC input voltage.

Depending on the temperature of the heating element, the operating circuit stops the power supply to the heating element for the remaining fraction of the positive and/or negative half-wave of the AC power after the measurement.

In case of overheat of the heating element the power supply to the heating element will be stopped immediately after measuring the temperature. Since the measurement will be performed at least once each period of the AC power, the power can continuously be reduced by cutting half-waves, e.g. for a slight overheat only one half-wave needs to be cut off while for higher temperatures, more and/or successive half-waves need to be cut off to reduce the temperature to a save level.

The heater wire control circuit may further comprise a cycle unit for setting the duration of a duty cycle, e.g. to include a fixed power mode on-time and a variable relaxing mode off-time. During the power mode, the power supply to the heating element depends on the temperature of the heating element as described above. During the relaxing mode, the power supply to the heating element is off, the heating element will cool down. The duration of the relaxing mode is depending on a user setting which is variable between “High”, “Mid” and “Low”, corresponding to a duration of the relaxing mode of 8 s, 19 s and 38 s. The duration of the power mode is fixed to be 10 s. Other values are possible. More and/or different user settings and relaxing mode durations are possible.

In case of a severe overheat of the heating element, the relaxing mode set by the user can be overruled and can be increased to a longer time period, e.g. 37 s at user setting “High”. This feature prevents destruction of the heating element due to overheating based on a local hot spot.

The heater wire control circuit may further comprise a timer module, which turns off the AC power from the heating element after a preset time, e.g. after 10 hours. This timer module will be activated in case of prolonged use of the heater wire control circuit and prevents unneeded waste of electrical power and reduces the risk of harmful damage to the heating element and its surroundings when the user forgets to turn it off.

An additional safety feature in form of a thermal fuse may be included in the heater wire control circuit. This thermal fuse will disconnect the heater wire control circuit from the AC power supply in case of a short circuit preventing fire hazards or risk of electrical shock.

A method to operate a heating element according to the present invention may be characterised in that the temperature of the heating element is determined at every positive and/or negative half-wave of the AC power and that the power supply to the heating element is set depending on said temperature.

The temperature of the heating element can be determined at a beginning fraction of every positive and/or negative half-wave.

The method to operate a heating element may comprise the following steps:
a) measuring the temperature of the heating element (21) at the beginning fraction of every positive and/or negative half-wave,
b) evaluating the power setting needed for the remaining half-wave depending on said temperature,
c) setting the power supplied to the heating element (21) depending on said temperature and/or a user setting.

According to the present invention, another embodiment of a method to operate a heating element, which can be regarded at its own or in combination with the above mentioned embodiment, is characterised in that a connection is provided between a operating circuit and the heating element to determine the temperature of the heating element and that the power supply to the heating element is stopped by the operating circuit depending on said temperature. The connection between the operating circuit and the heating element is provided for a given length of time T1 starting at T0, and/or as long as the rising slope of the AC input voltage wave is below a given threshold value.

Preferably the length of time T1 is a fraction of the period of the AC power, less than 10%, preferably between 0% and 5%, most preferably between 0.25% and 1.5%. The starting point TO for the time duration T1 preferably is at each positive and/or negative zero crossing of the AC power. If the measurement is controlled by a threshold value, then the threshold value of the rising slope of the AC input voltage is less than 50%, preferably between 0% and 30%, most preferably between 1.5% and 9.5% of the AC line voltage. This method makes sure that at least one measurement is performed for each AC period. Other values for the times T0, T1 and the threshold voltage are possible.

In an additional aspect of the invention, the power supply to the heating element is set by enabling or disabling the positive and/or negative half-wave of the remaining fraction of the period of the AC power after each measurement.

In yet another aspect of the present invention, the heating element is operated in different duty cycles comprising
a) a power mode of given length, during which at least partial power is applied to the heating element depending on the temperature of the heating element, and
b) a relaxing mode of variable length, during which the power supply is turned off.

The duration of the power mode is fixed, e.g. to 10 s, while the length of the relaxing mode is depending on a user setting which is variable between “High”, “Mid” and “Low”, corresponding to a duration of the relaxing mode of 8 s, 19 s and 38 s. More and/or different user settings and relaxing mode durations are possible.

In case of a severe overheat of the heating element the relaxing mode set by the user can be overruled and can be increased to a longer time period, e.g. 37 s at user setting “High”. This feature prevents destruction of the heating element due to overheating based on a local hot spot.

A further aspect of the invention includes the operation of the heating element in a “Fast mode initial” heating up for a preset time. During this “Fast mode initial” heating up, the determination of the temperature of the heating element is performed and/or the power supply to the heating element is influenced by the interrupting means or the operating circuit similar to the normal power mode operation. This allows a fast heating up to the user defined temperature setting after the heating element has completely cooled down, e.g. when first used after storage. The duration for this “Fast mode initial” heating up is between 1 and 5 minutes, preferably 2 minutes. Other settings are possible.

A further aspect of the invention includes the operation of the heating element characterised in that the power supply to the heating element is disabled after a preset time, preferably after 10 hours.

A flexible heating element according to the present invention comprises a core wire surrounded by a layer with negative temperature coefficient (NTC) property and a heater wire helically wound around the NTC layer.

The core wire of the heating element may have a low resistance between 0.5 Ω/m and 1.0 Ω/m, preferably 0.86 Ω/m. The core wire may be a stranded wire, in particular comprising multiple tinsel wire ribbons, preferably including at least one polyester fibre to increase the tensile strength of the core wire. The core wire is stranded to obtain optimal flexing characteristics. The heating element can be designed according to standard UL AWM Style #11019 using PVC as a base material. Other materials and wire constructions are possible.

The invention will now be explained in more detail with reference to the embodiments and accompanying drawings which show:
a heating element;
the resistance vs. temperature diagram of the NTC layer of a heating element;
duty cycles according to various temperature settings;
duty cycles during self healing;
duty cycles during self healing in case of severe overheat;
a simplified block diagram of a heater wire control circuit;
another simplified block diagram of a heater wire control circuit;
a circuit diagram of a heater wire control circuit.

In FIG. 1 a flexible heating element 21 according to the present invention is shown. The element consists of a central core wire 22, a first insulation layer 24 surrounding the core wire 22, a heater wire 23 and a second insulation layer 25 covering the heating element 21. The core wire 22 exhibits a low resistivity of 0.86 Ω/m and is a stranded multiple tinsel wire ribbon interwound within a polyester fibre. The number of tinsel wires is 4. The first insulation layer 24 is made of doped PVC exhibiting negative temperature coefficient (NTC) property. Various base materials with different dopants are possible. The thickness of the first insulatin layer is 0.30 mm, the diameter of the inner insulation is 1.06 mm. The heater wire 23 is helically wound around the first insulation layer 24 with a pitch being chosen such that the heater wire 23 exhibits a desired resistance over the complete length of the heating element 21. In the example shown, the heater wire exhibits a pitch of 15 turns per inch, resulting in a resistance of the heater wire 23 of the heating element 21 of 54.5 Ω/m. The second or outer insulation layer 25 is made of PVC having a thickness of 0.52 mm resulting in an overall diameter of the heating element of 2.10 mm. The heating element can be designed according to standard UL AWM Style #11019 using PVC as a base material. Other materials as well as other dimensions and/or constructions might also be used.

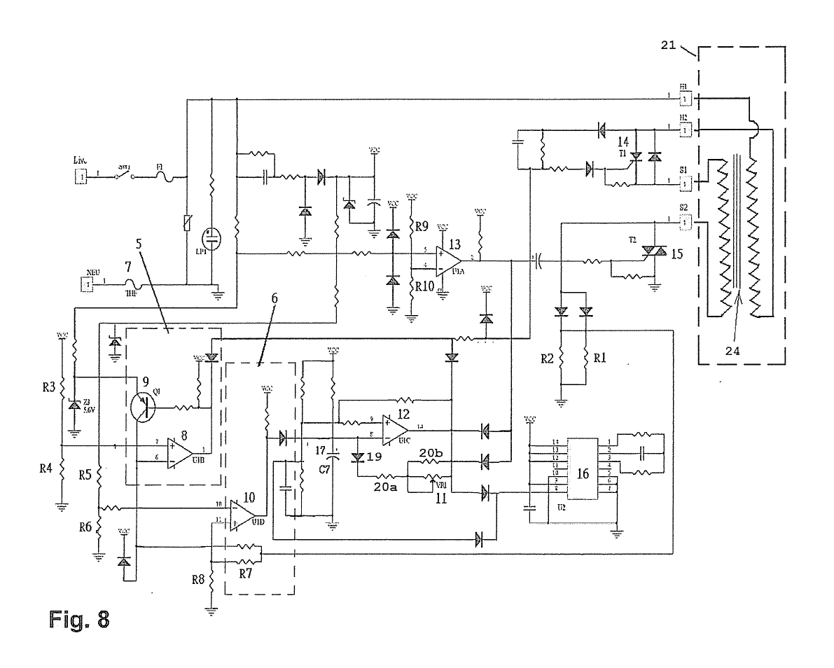

By using such a construction of the heating element 1 and connecting the core wire 22 and the heater wire 23 in series, as it is shown in FIG. 8, the electromagnetic field of the heating element is very low, since the core wire 22 acts as return path for the current through the heater wire 23.

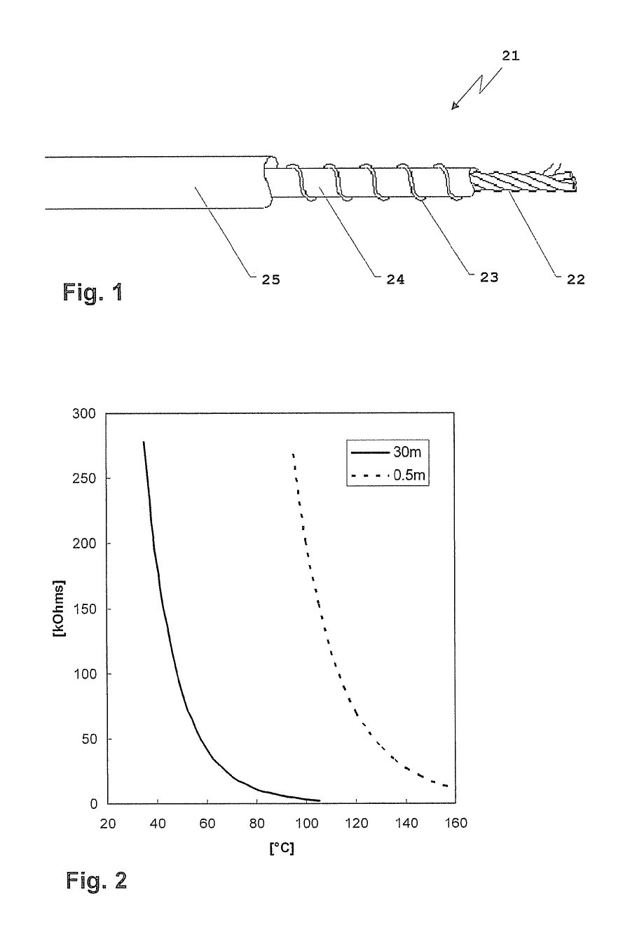

FIG. 2 shows the resistance vs. temperature diagram of the NTC layer of the heating element according to the present invention. The solid line illustrates the NTC resistance of a typical heating element with a length of 30 m, where the complete heating element is at the same temperature. The dashed line represents the NTC resistance of 0.5 m of the heating element which is at a raised temperature. In case of local hot spot, e.g. 0.5 m of the heating element is at about 140° C. due to a overheating caused by folding or bunching of the blanked, the total resistance of the NTC will be calculated as a parallel circuit of the 30 m or 29.5 m resistance of the NTC at normal temperature with the NTC resistance of the 0.5 m at raised temperature. A local hot spot temperature that is higher than the average temperature of the heating element becomes a major dominant contributor to the total resistance.

For example, the resistance of the NTC is about 85 kΩ, when the full length of heating element is at a temperature of 50° C. When a local hot spot occurs caused from abnormal use, the temperature of approx. 0.5 m of heating element increases up to 140° C., the impedance of this local hot spot becomes 25 kΩ resulting in a total resistance of 19.3 kΩ.

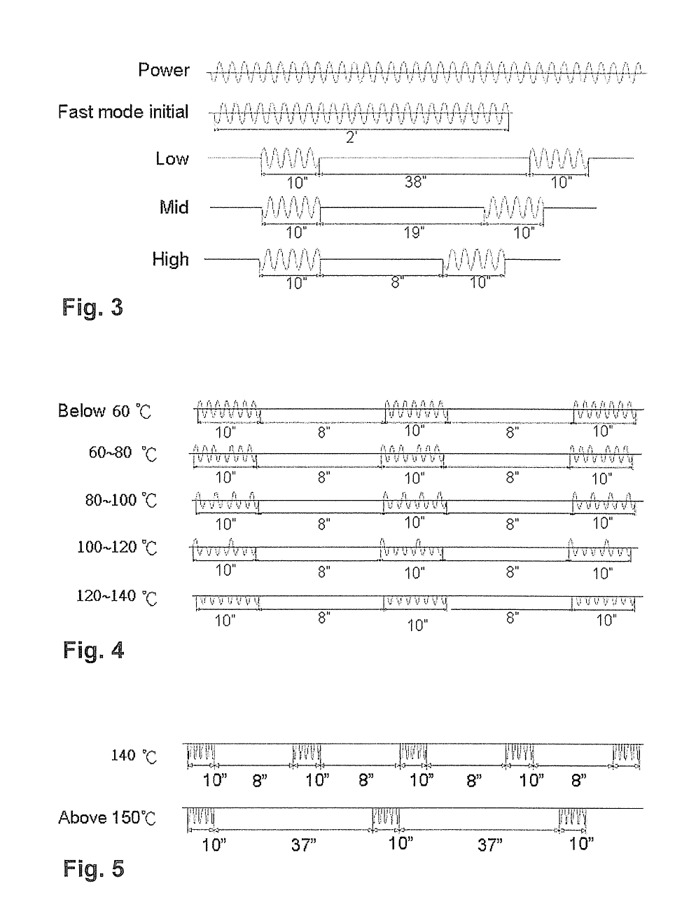

In case of maximum heat setting, setting “High” according to FIG. 3, the temperature of the heating element should not be higher as 55° C., resulting in a resistance of the NTC of about 30 kΩ. The low resistance of 19.3 kΩ from above given example will be detected by the heater wire control circuit, which reduces the power to prevent the heating element at the hot spot from being damaged.

FIG. 3 shows typical duty cycles with respect to the temperature settings “Low”, “Mid”, “High” and “Fast mode initial”. Each duty cycle generally consists of a power mode, where power is applied to the heating element and the heater wire acts as a resistance heating up the heating element, followed by a relaxing mode, where no power is applied, to cool down. For each of the three possible temperature settings “Low”, “Mid” and “High”, the power mode lasts exactly 10 s while the duration of the relaxing mode varies between 38 s for “Low”, 19 s for “Mid” and 8 s for “High”.

When the heater wire control circuit is switched on for the first time after a longer time of non-use respectively after complete cool down, the heater wire control circuit automatically switches to “Fast mode initial” for the first two minutes for a fast heating up. During this “Fast mode initial”, the power is permanently turned on without relaxing mode. As soon as the two minutes have passed, the heater wire control circuit is set to the temperature setting as chosen by the user.

The self healing feature of the heater wire control circuit in case of a hot spot with typical duty cycles for the temperature setting “High” is illustrated in FIG. 4. For temperatures below 60° C., respectively during normal operation, the duty cycle consists of a 10 s power mode followed by a 8 s relaxing mode as described in FIG. 4. When the temperature of a part of the heating element is increased to above 60° C., e.g. a hot spot is built, then positive half-waves of the power mode are cut away. The number of removed half-waves depends on the temperature at the hot spot, respectively. The higher the temperature of the hot spot or the lower the resistance of the NTC at the hot spot, the more half-waves are cut away by the heater wire control circuit. In the example given, for temperatures between 60° C. and 80° C. every fourth positive half-wave is cut away. When the temperature is between 80° C. and 100° C., then every second half-wave disappears while for temperatures between 100° C. and 120° C. three out of four half-waves are cut off. When the temperature is above 120° C., then every positive half-wave is blocked. The duty cycles shown are examples only, temperature and number of half-waves cut away may vary. Whether or not to cut away a positive half-wave is decided at the beginning of each positive half-wave.

For the user setting “High”, the duty cycles in case of severe overheat with temperatures higher than 150° C. is shown in FIG. 5. With temperatures until about 140° C., the power is reduced by cutting off more and more positive half-waves, in extremis each half-wave. If the temperature can not be decreased with above described power reduction and reaches 150° C. or more, then the relaxing mode of the duty cycle is increased from 8 s to 37 s additionally. This reduces the average power supplied to the heating element substantially and allows additional cooling.

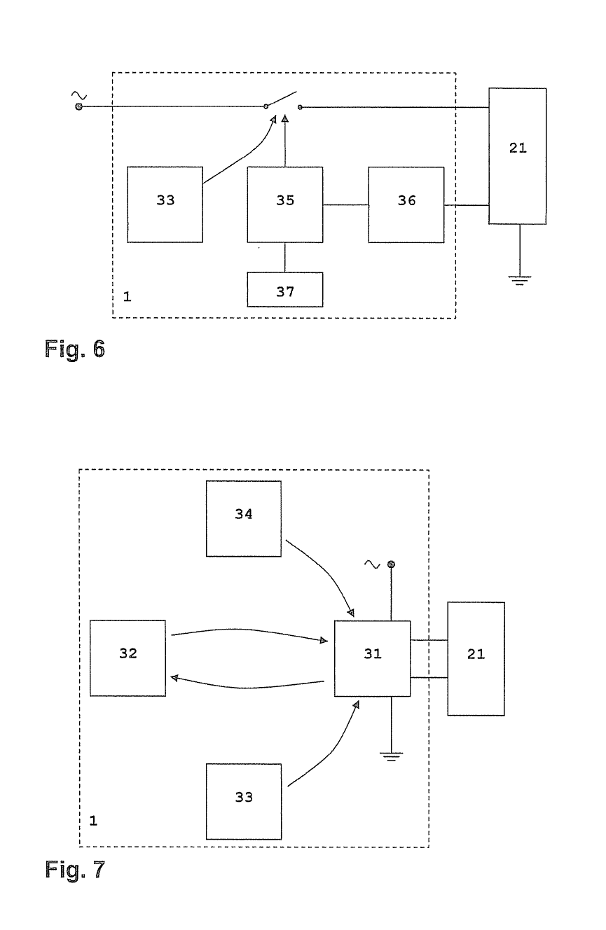

In FIG. 6 a simplified block diagram of a heater wire control circuit 1 is shown. The heater wire control circuit 1 shown comprises an operating circuit 35, a switching element 36, a cycle unit 37 and a timer module 33. The operating circuit 35 is able to stop the power supply to the heating element 21 depending on the temperature of the heating element 21. The operating circuit 35 further is able to determine the temperature of the heating element 21. The temperature can be determined by measuring any electrical characteristic of the heating element 21 which is related to the temperature, e.g. its voltage drop, its current or its resistance.

To determine the temperature of the heating element 21, the operating circuit 35 needs a connection to the heating element 21, which is established by the switching element 36. This connection is not a permanent connection but is only allowed during a certain time. This time is preferably set to start at each positive and/or negative zero crossing of the AC input power and its duration is only a fraction of the period of the AC power. This fraction of the AC power period is less than 10%, preferably between 0% and 5%, most preferably between 0.25% and 1.5% of the AC period. The temperature of the heating element 21 is measured at least once every AC period.

Depending on the temperature of the heating element 21, the operating circuit 35 stops the power supply to the heating element 21 for the remaining fraction of the positive and/or negative half-wave of the AC power after the measurement, if the temperature of the heating element 21 is to high.

The heater wire control circuit 1 further comprises a cycle unit 37, which basically allows the operating circuit 35 and the heater wire 21 to be operated in duty cycles. Each duty cycle consists of a power mode and a relaxing mode. During the power mode, the AC power is applied to the heating element 21 and the temperature of the heating element 21 is controlled by the operating circuit 35 at least once per AC period. The duration of the power mode is generally constant and set to be 10 s, but might also be set differently and/or variable. The duration of the relaxing mode is depending on a user setting which is variable between “High”, “Mid” and “Low”, corresponding to a duration of the relaxing mode of 8 s, 19 s and 38 s respectively. More and different user settings and relaxing mode durations are possible. In case of a severe overheat of the heating element 21, the relaxing mode set by the user can be overruled as described in FIG. 5 to prevent destruction of the heating element 21.

The timer module 33 is an additional safety feature and turns off the power supply to the heating element 21 after 10 hours of continuous use.

In FIG. 7 another simplified block diagram of a heater wire control circuit 1 is shown. Basically the heater wire control circuit 1 consists of an interrupting means 31 and a control means 32. The interrupting means 31 is able to manipulate the power supply to a connected heating element 21 by either letting pass the positive and negative half-wave of the AC power, only the positive or negative half-wave or none of both. Once every AC power cycle during a small fraction of the AC cycle, the resistance of a heating element 21 is measured by the control means 32. Depending on the value measured, the control means 32 decides what switching state is appropriate for the remainder of the AC cycle and sets the interrupting means 31 accordingly. The exact timing of the measurement of the heating element resistance is determined by the trigger device 34. In the example given, the fraction of the AC cycle for measuring is no longer than 250 μs and the measurement is triggered exactly at the positive zero crossing of the AC cycle. The trigger device 34 sets the interrupting means 31 into the status that no half-wave is supplied to the heating element 21 for above described 250 μs and the measurement can be performed by the control means 32.

After a preset time of operation, a timer module 33 sets the interrupting means 31 permanently into the status that no half-wave is supplied to the heating element 21 in order to prevent unnecessary energy consumption. This preset time is set to be 10 hours, other values are possible.

FIG. 8 shows a circuit diagram of a heater wire control circuit of a heating blanket according to this invention. During operation, the comparator U1A 13 will output “high level” as soon as the rising slope of the positive half-wave of the AC line power reaches the same voltage as defined by the voltage divider R9, R10. The “high level” signal at the output of comparator U1A 13 in turn will then switch on triac T2 15. Due to the time needed for the positive half-wave of the AC line power to reach the preset value of the voltage divider R9, R10, the triac T2 15 is switched on with a certain delay. This delay timing in the example given is 250 μs, other values are possible. The triac T2 15 is turned on after the defined delay time after each positive zero crossing of the AC line power. Within the first 250 μs where triac T2 15 is still turned off, a half-wave circuit 5 will determine whether or not to turn on thyristor T1 14.

During normal operation of the heating element 21, e.g. the temperature of the complete NTC insulation layer 24 being below 60° C., the leakage current through the NTC insulation layer 24 is relatively small. The voltage signal on the negative input of the comparator U1B 8 will be smaller than the signal at the positive input coming from voltage divider R3, R4. The comparator's U1B 8 output therefore will be “high level” resulting in thyristor T1 14 to be kept on or being turned on. Therefore the remaining half-wave will pass through thyristor T1 14.

During normal operation of the heating element, the circuit is alternating between power mode and relaxing mode. The duration of the power mode is determined by the charging time of the capacitor C7 17. As long as the voltage signal of the capacitor C7 17, which is applied to the negative input of the comparator U1C 12, is below the reference voltage on the positive input of the comparator U1C 12, the comparators output is “high level”. The time for charging the capacitor in the example given is 10 s but might also be chosen differently. As soon as the capacitor C7 17 is charged and the voltage signal on the negative input of the comparator U1C 12 is higher than the reference voltage signal on its positive input, the comparator U1C 12 outputs “low level”, turning off triac T2 15 and thyristor T1 14 by forcing the voltage of their gates to “low level”. This will start the relaxing mode. The duration of the relaxing mode is determined by the discharging of the capacitor C7 17 through the diode 19 and resistors 20a, 20b and variable resistor VR1 11. As soon as the voltage of the capacitor C7 17 is below the reference voltage signal on the positive input of the comparator U1C 12, its output will change to “high level” again, which enables the power mode by allowing triac T2 15 to be switched on. Depending on the setting “Low”, “Mid” or “High” of the variable resistor VR1 11 or the user setting respectively, the duration of the relaxing mode is 38 s, 19 s or 8 s in the example given. Different settings are possible.

In case of overheating of a part of or the whole heating element 21 occurred from abuse, e.g. folding or bunching of the blanket, the resistance of the NTC insulation layer 24 will become lower, e.g. said 19.3 kΩ. The leakage current through the NTC layer 24 will increase and therefore create a positive signal at the negative input of the comparator U1B 8. If this input signal becomes bigger than the signal at the positive input coming from the voltage divider R3, R4, then the comparator U1B 8 outputs “low level”, which turns off thyristor T1 14. With thyristor T1 14 turned off, no positive half-waves are allowed to pass.

Since triac T2 15 can only be turned on after the delay timing of 250 μs at the beginning of every positive half-wave, this comparison or measurement is performed every positive half-wave.

In case the hot spot is continuously getting worse and the temperature increases to above 150° C. the relaxing mode will be increased as shown in FIG. 6. Caused by the resistance of the NTC insulation layer 24 being even lower than the above described 19.3 kΩ, the relaxing mode circuit 6 receives at the positive input pin of comparator U1D 10 a signal higher than at its negative input pin. The comparator U1D 10 therefore outputs “high level” to charge the capacitor C7 17 with Vcc. As long as capacitor C7 17 is not yet discharged, comparator U1C 12 outputs “low level” which will keep triac T2 15 and thyristor T1 14 turned off. The discharge time of the capacitor C7 17 for the user setting “High” is about 37 s but may also be chosen to be different. The discharge time for the user setting “Mid” is about 43.2 s. Although chances are almost impossible that a hot spot will build up at the user setting “Low”, the discharge in this case would be about 52.8 s.

In case of a complete failure of the heating element 21, e.g. a short circuit between the core and the heater wire, the resistors R1 and R2 will heat up during the first 250 μs of the positive half-wave and thermal fuse 7, will burn down to completely disrupt the line power supply. Although in the circuit diagram of FIG. 3, the thermal fuse 7 is shown away from resistors R1 and R2, in reality thermal fuse 7 is very close or in direct thermal contact with at least one, preferably both resistors R1 and R2.

When operating the circuit for the first time or after storing for a prolonged time, capacitor C7 17 is fully discharged. Therefore, the power mode time needed for the first charging respectively for the voltage of the negative input of comparator UC1 12 to reach a value higher than what is applied on the positive input will be longer than the time used during normal operation. This prolonged time enables a “Fast mode initial” heat up and is in the example given approx. 2 min. Although, this “Fast mode initial” lasts longer than the usual power mode, the function is exactly the same. The measurement is performed at each positive zero crossing and it will be determined whether or not to allow the positive half-wave. This operating mode is only available on the first turning on of the heater wire control circuit after complete discharge of the capacitor C7 17. Other variants on the availability of the “Fast mode initial” are also possible, e.g. when the heating element 21 has completely cooled down.

A timer IC 16 measures the time passed from switching on the heater wire control circuit. After a preset time, e.g. of 10 h, the timer IC 16 outputs “low level” to its output pin 18, which in turn pulls down the output of comparator U1C 12 which then turns off thyristor T1 14 and triac T2 15. With both thyristor T1 14 and triac T2 15 being switched off, no power can be consumed in the heating element 21. This auto power off is an additional safety feature to prevent damage of the heater wire control circuit and also to avoid unnecessary consumption of electricity.

1. A heater wire control circuit to control the AC power supply of a connected heating element, comprising
a) interrupting means having at least three switching states with regard to the AC power supplied to the heating element:
i) both half-waves on,
ii) positive or negative half-wave off,
iii) both half-waves off, and
b) control means to determine the temperature of the heating element, and to decide on the switching status of the interrupting means depending on said temperature and/or a user setting
c) a trigger device to switch the interrupting means to “both half-waves off” at every positive and/or negative zero crossing of the AC power
i) for a given length of time T1, and/or
ii) as long as the voltage during the rising slope of the AC input voltage is below a predetermined threshold value,
enabling the control means to determine the temperature of the heating element.

2. A heater wire control circuit (1) to control the AC power supply of a connected heating element comprising means to determine the temperature of the heating element at every positive and/or negative half-wave and to set the power supply to the heating element depending on said temperature, said means comprise
a) a operating circuit being able to stop the power supply to the heating element depending on the temperature of the heating element when power is applied and
b) a switching element providing a connection between the operating circuit and the heating element when power is applied
i) for a given length of time T1, and/or
ii) as long as the voltage during the rising slope of the AC input voltage is below a predetermined threshold value.

3. The heater wire control circuit according to claim 2, wherein the start of Ti is at each positive and/or negative zero crossing of the AC power.

4. The heater wire control circuit according to claim 1 or 2, wherein the length of time T1 is a fraction of a period of the AC power, less than 10%.

5. The heater wire control circuit according to claim 1 or 2, wherein the threshold value is less than 50% of the AC line voltage.

6. The heater wire control circuit according to claim 2, wherein the operating circuit is able to stop the power supply for the remaining fraction of the positive and/or negative half-wave of the AC power.

7. The heater wire control circuit according to claim 1 or 2 comprising a cycle unit for setting the duration of a duty cycle, e.g. a fixed power mode on-time and a variable relaxing mode off-time.

8. The heater wire control circuit according to claim 1 or 2, further comprising a timer module, which turns off the AC power from the heating element after a preset time.

9. The heater wire control circuit according to claim 1 or 2, further comprising a thermal fuse, which disconnects the heater wire control circuit from the AC power in case of a short circuit.

10. A method to operate a heating element, wherein the temperature of the heating element is determined at a beginning fraction of every positive and/or negative half-wave and the power supply to the heating element is set depending on said temperature.

11. The method to operate a heating element according to claim 10 comprising the steps:
a) measuring the temperature of the heating element at the beginning fraction of every positive and/or negative half-wave,
b) evaluating the power setting needed for the remaining half-wave depending on said temperature,
c) setting the power supplied to the heating element depending on said temperature and/or a user setting.

12. A method to operate a heating element, wherein a connection is provided between a operating circuit and the heating element to determine the temperature of the heating element
a) for a given length of time T1 starting at T0, and/or
b) as long as the rising slope of the AC input voltage wave is below a given threshold value, and
that the power supply to the heating element is stopped by the operating circuit depending on said temperature.

13. The method to operate a heating element according to claim 12, wherein the length of time T1 is a fraction of a period of the AC power, less than 10%.

14. The method to operate a heating element according to claim 12, wherein the time T0 is at each positive and/or negative zero crossing of the AC power.

15. The method to operate a heating element according to claim 12, wherein the threshold value of the rising slope of the AC input voltage is less than 50% of the AC line voltage.

16. The method to operate a heating element according to claim 12, wherein the operating circuit is able to stop the positive and/or negative half-wave of the remaining fraction of the period of the AC power.

17. The method to operate a heating element according to claim 10 or 12, wherein the heating element is operated in different duty cycles comprising
a) a power mode of given length, during which at least partial power is applied to the heating element depending on the temperature of the heating element, and
b) a relaxing mode of variable length, during which the power supply is turned off.

18. The method to operate a heating element according to claim 17, wherein the length of the relaxing mode is depending on a user setting and/or on the temperature of the heating element.

19. The method to operate a heating element according to claim 10 or 12, wherein a “Fast mode initial” heating up for a preset time is enabled during which
a) a determination of the temperature of the heating element takes place, and/or
b) the power supply to the heating element is influenced by the interrupting means or operating circuit.

20. The method to operate a heating element according to claim 19, wherein the preset time for “Fast mode initial” heating up is between 1 and 5 minutes.

21. The method to operate a heating element according to claim 10 or 12, characterised in that the power supply to the heating element is disabled after a preset time.
